(19) United States
(12) Patent Application Publication
(10) Pub. No.: US 2010/0156618 A1
(43) Pub. Date: Jun. 24, 2010

(54) Tire Monitoring System Without Battery

(76) Inventor: Jiann-Huoy Huang, Zhonghe City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/640,071

(22) Filed: Dec. 17, 2009

(30) Foreign Application Priority Data
Dec. 18, 2008 (TW) 097149303

(51) Int. Cl. B60C 23/02

(52) U.S. Cl. 340/442

(57) ABSTRACT

The present invention relates to a tire monitoring system without battery, which is firmly set on the wheel rim or in the tire to monitor the status of the tire. The present invention includes a tire status sensor and a generator. The former is set on the wheel rim or the gas nozzle, and the latter is firmly set on the wheel rim. The generator provides the energy to make the tire status sensor monitor the status of the tire.

### BACKGROUND OF THE INVENTION

1. Field of the Invention

The present invention relates to a tire monitoring system; more particularly, the present invention relates to a tire monitoring system capable of normally monitoring a status of a tire without using a battery.

2. Description of the Related Art

Currently, a direct-type tire monitoring system comprises a pressure sensor, a temperature sensor, an electronic circuit and a battery for being installed in a tire. According to the above design, the tire monitoring system can monitor a status of an in-use tire so as to obtain precise data. However, the conventional tire monitoring system has some disadvantages caused by the battery. For example, if the battery needs to be replaced, a user might need to remove the tire first; or, if an environmental temperature is too high or too low, the battery might fail. Further, in order to achieve an energy-saving function, the electronic circuit is not always performing a tire monitoring task (including the task of transmitting data signals). Therefore, the conventional tire monitoring system cannot provide a real-time tire monitoring status, thereby resulting in a poor precaution function.

Therefore, it is necessary to provide a tire monitoring system without battery to mitigate and/or obviate the aforementioned problems.

### SUMMARY OF THE INVENTION

It is an object of the present invention to provide a tire monitoring system without battery, so as to avoid system failure due to an over-high or over-low environmental temperature.

It is another object of the present invention to provide a tire monitoring system without battery, so as to avoid battery replacement.

It is yet another object of the present invention to provide a tire monitoring system without battery, so as to immediately monitor and report the status of the tire, thereby improving driving safety.

To achieve the abovementioned objects, the tire monitoring system without battery of the present invention is set in a tire and/or on a wheel rim of the tire (hereinafter referred as “the wheel rim”). The tire comprises an interior space, and the wheel rim (including a gas nozzle) can be a conventional steel rim, an aluminum alloy rim or an equivalent rim made of other materials. The tire monitoring system without battery of the present invention comprises a tire status sensor and a generator. The former is firmly set on the wheel rim or the gas nozzle, and is used for monitoring a status of the tire; while the latter is firmly set on the wheel rim. The tire status sensor and the generator are electrically connected to each other.

The abovementioned tire status sensor comprises at least one sensing element and an electronic circuit. There can be one or more sensing elements used for sensing the pressure, temperature or other features. The electronic circuit can further comprise a data signal transmitter and a micro-controlling unit. The data signal transmitter transmits each kind of processed signals to a data signal receiver installed in a vehicle. The micro-controlling unit is used for processing the signals, and is mainly composed of general electronic components, comprising passive components and active components (including integrated circuits, a single chip, a microprocessor or the like). The micro-controlling unit can be combined with the data signal transmitter to form an electronic circuit combination.

The abovementioned generator can generate energy by means of the theory that “the gravity moment greater than the magnetic moment forces the magnetic field to cross the winding set (coil) or forces the winding set to cross the magnetic field”. The generator can be implemented into three major structures, which will be described in the detailed description of the preferred embodiment hereinafter.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a schematic drawing of one preferred embodiment according to the present invention.

FIG. 2 illustrates a schematic drawing of another embodiment according to the present invention.

FIG. 3 illustrates a schematic drawing of the generator according to one embodiment of the present invention.

FIG. 4 illustrates a schematic drawing of the stator of the generator according to another embodiment of the present invention.

FIG. 5 illustrates a schematic drawing of the stator of the generator according to yet another embodiment of the present invention.

FIG. 6 illustrates a schematic drawing of the generator according to another embodiment of the present invention.

FIG. 7 illustrates a functional block diagram of the tire status sensor 3 according to the present invention.

### DETAILED DESCRIPTION OF THE PREFERRED EMBODIMENT

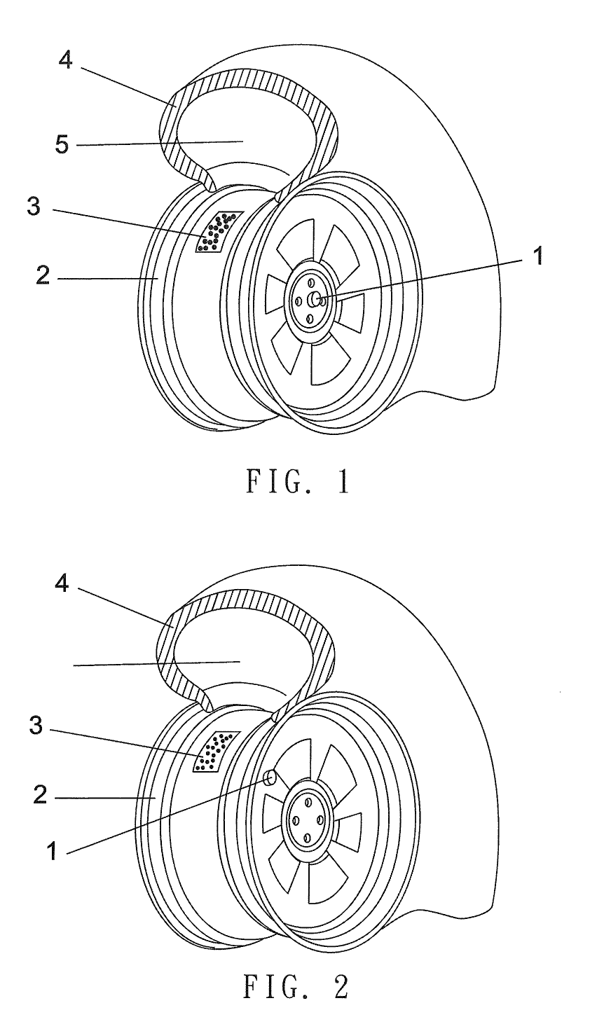

Please refer to FIG. 1, which illustrates a schematic drawing of one preferred embodiment according to the present invention. A generator 1 is set in the center of a wheel rim 2 of a tire 4, and a tire status sensor 3 is set in an interior space 5 formed between the tire 4 and the wheel rim 2. When a vehicle is running, its engine drives the wheel rim 2 and the tire 4 to rotate, such that the wheel rim 2 can spin to drive the generator 1 to generate energy, thereby driving the tire status sensor 3 to operate via an electrical connection, so as to monitor the status of the tire 4 and then to transmit a signal via a data signal transmitter. The vehicle itself further comprises a data signal receiver used for receiving the signal transmitted from the data signal transmitter. After the signal is processed, the driver of the vehicle can be informed by the processed signal in the form of audio, video or other types, so as to improve driving safety. The aforementioned data signal receiver and the human-machine interface device used for informing the driver about the status of the tire are irrelevant to the scope of the present invention, therefore there is no need for further description.

Please refer to FIG. 2, which illustrates a schematic drawing of another embodiment according to the present invention. As shown in FIG. 2, the generator 1 of the present invention is not set in the center of the wheel rim 2 in this embodiment. The generator 1 and the tire status sensor 3 are electrically connected to each other. In this embodiment, the wheel rim 2 and the tire 4 are designed with a more complicated weight arrangement.

Besides the embodiments shown in FIG. 1 and FIG. 2, the generator 1 of the present invention can also be set in the interior space 5 formed between the wheel rim 2 and the tire 4, wherein such design also result in a more complicated weight arrangement. Then, the present invention can normally operate after the generator 1 and the tire status sensor 3 are electrically connected to each other. Further, the present invention can be installed with two or more generators 1 at the same time, not only to provide a weight arranging function but also to generate more energy for being provided to the tire status sensor 3 or other circuit tasks. Anyway, no matter how many or where the generator 1 is set, the present invention can normally operate as long as the generator 1 and the tire status sensor 3 are electrically connected to each other.

The abovementioned generator 1 can generate energy by means of the theory that “the gravity moment greater than the magnetic moment forces the magnetic field to cross the winding set or forces the winding set to cross the magnetic field”. The generator 1 can be implemented into three major types according to different materials, structures or shapes, which will be described hereinafter in more detail.

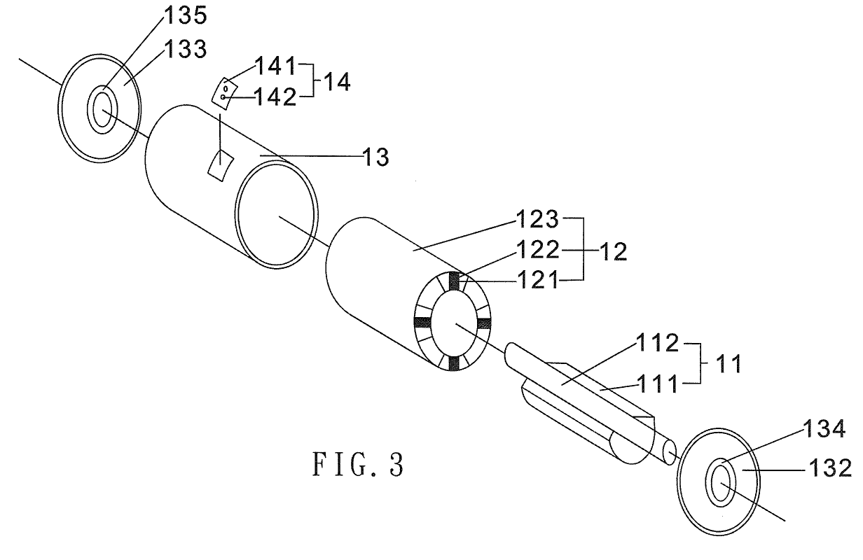

Please refer to FIG. 3, which illustrates a schematic drawing of the generator 1 according to one embodiment of the present invention. The generator 1 is composed of a stator 11, a rotor 12, a barrel 13, a front cover 132, a back cover 133 and an energy lead-out terminal set 14. In this embodiment, when the generator 1 is running, the stator 11 refers to the stationary part of the generator 1, and the rotor 12 refers to the rotating part of the generator 1. The above stator 11 is composed of a fan-shaped cylinder magnetic material 111 and a supportive central shaft 112, so as to form a fan-shaped cylinder having a supportive central shaft with its centroid not located on the supportive central shaft 112 (i.e. the centroid is not located on the central shaft of the generator 1). In other words, the generator 1 of this embodiment is composed of an eccentric shaft structure. The rotor 12 is firmly set in the barrel 13, and is composed of a winding set 121, a permeability material 122 and a supporting structure 123. The permeability material 122 is not necessary and can be ignored. Further, the winding set 121 can be directly set in the barrel 13. The supporting structure 123 can also be ignored. The barrel 13 is firmly set onto a rotatable object (such as the center of the wheel rim 2) in the form of a circular cylinder. The barrel 13, the front cover 132 and the back cover 133 form the covering of the entire generator 1 and support the structure of the rotor 12 and the stator 11. The barrel 13 can be used as part of a magnetic circuit. The barrel 13, the front cover 132 and the back cover 133 can be formed in one piece so as to reduce assembly components. Or, the barrel 13 and the wheel rim 2 can be formed in one piece, such that a barrel-shaped concave cylinder can be formed on the wheel rim 12 for directly placing the winding set 121. A front bearing 134 is set on the front cover 132, and a back bearing 135 is set on the back cover 133. The front bearing 134 and the back bearing 135 can be replaced by a drilled wear-resistant material as long as it can support the stator 11. The energy lead-out terminal set 14 is firmly set on the covering of the generator 1, and is composed of an insulation spacer 141 and a lead-out terminal 142, so as to lead out the energy generated by the winding set 121 of the rotor 12 for being provided to the electronic circuit of the tire status sensor 3. If the energy can be led out directly via the winding set 121, the energy lead-out terminal set 14 can be ignored.

The operations of the abovementioned generator 1 are as follows: when the wheel rim 2 (covered by the tire 4) is spinning and rotating, the barrel 13 firmly set on the wheel rim 2 would rotate accordingly, and the winding set 121 firmly set on the barrel 13 would rotate along the barrel 13 as well (i.e. the wheel rim 2, the barrel 13 and the winding set 121 act as the rotating part of the generator 1). Because the stator 11 is an eccentric shaft structure, if the moment caused by the gravity is greater than a reacted magnetic moment caused by an output current of the winding set 121 of the rotor 12 and a moment caused by friction, the stator 11 would only tilt towards a certain angle (with an included angle between the stator 11 and the gravity direction less than 90 degrees) without rotating accordingly. Therefore, a relative motion is formed between the winding set 121 and the magnetic material 111, a conductor and a magnetic field cut with each other, the winding set 121 has an induced electromotive force, and the energy lead-out terminal set 14 (or a conducting wire) firmly set on the barrel 13 can output the energy. Because there is no relative motion between the energy lead-out terminal set 14 and the wheel rim 2, the energy lead-out terminal set 14 can be directly and electrically connected to the wheel rim 2, such that the energy can be outputted to the electronic circuit of the tire status sensor 3 firmly set on the wheel rim 2.

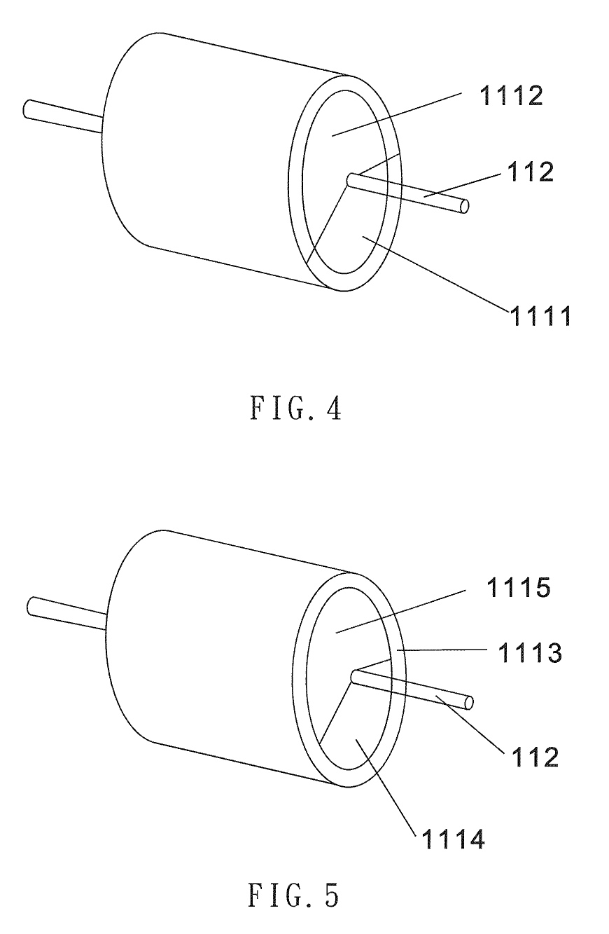

Please refer to FIG. 4, which illustrates a schematic drawing of the stator 11 of the generator 1 according to another embodiment of the present invention. The stator 11 is composed of at least two materials of different densities. As shown in FIG. 4, the density of a lower part 1111 of the stator 11 is greater than the density of an upper part 1112 of the stator 11. Therefore, the centroid of the stator 11 is not located on the central shaft 112, but is located on the lower part 1111 of the stator 11. When the rotor 12 rotates along the wheel rim 2, the stator 11 would not rotate accordingly because of the eccentric centroid of the stator 11. As a result, a relative motion is formed between the winding set 121 and the magnetic stator 11, so as to provide energy to the electronic circuit of the tire status sensor 3.

Please refer to FIG. 5, which illustrates a schematic drawing of the stator 11 of the generator 1 according to yet another embodiment of the present invention. The stator 11 is composed of a circular magnet 1113 and at least two materials of different densities. The density of a lower part 1114 of the stator 11 is greater than the density of an upper part 1115 of the stator 11. Therefore, the centroid of the stator 11 is not located on the central shaft 112, but is located on the lower part 1114 of the stator 11. The operations of this embodiment are the same as that of the embodiment shown in FIG. 4, therefore there is no need for further description. Of course, the upper part 1115 of the stator 11 of this embodiment can be ignored, which means, the upper part 1115 of the stator 11 is composed of air.

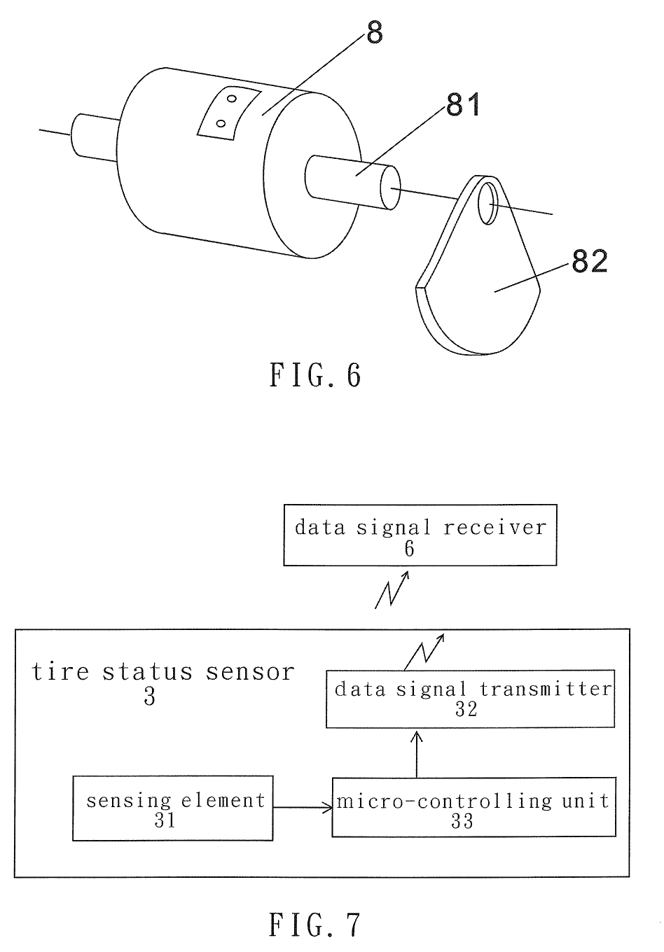

Please refer to FIG. 6, which illustrates a schematic drawing of the generator 1 according to another embodiment of the present invention. In this embodiment, a weight 82 is added (firmly set) to the central shaft 81 of the rotor part of a conventional AC generator, DC generator or DC motor 8, and is used as the stator 11 of the generator 1 of the present invention. The stator part (including the housing and the energy lead-out terminal) of the conventional generator is used as the rotor 12 of the generator 1 of the present invention, and is firmly set on the wheel rim 2. When the wheel rim 2 is spinning and rotating, the rotor 12 of the present invention (i.e. the stator part of the conventional generator) would be driven to rotate, while the stator 11 of the present invention (i.e. the rotor part of the conventional generator) would not rotate accordingly because of the weight 82. As a result, a relative motion is formed between the winding set 121 of the generator 1 and the magnetic field, so as to provide energy to the electronic circuit of the tire status sensor 3.

The abovementioned tire status sensor 3 is capable of sensing the pressure, temperature or other features of the tire 4. Please refer to FIG. 7, which illustrates a functional block diagram of the tire status sensor 3 according to the present invention.

The tire status sensor 3 comprises a sensing element 31, a data signal transmitter 32 and a micro-controlling unit 33. There can be one or more sensing elements 31 used for sensing the temperature, tire pressure or other features (such as humidity or contents of different gasses). The measured/sensed signals would be transmitted to the micro-controlling unit 33. The micro-controlling unit 33 is composed of electronic components (including passive components and active components), and is used for processing the signals. The data signal transmitter 32 can be a module or can be composed of electronic components, and is used for transmitting the signals processed by the micro-controlling unit 33. A data signal receiver 6 installed in the vehicle is used for receiving the processed signals and informing the driver about the processed signals. The data signal transmitter 32 and the micro-controlling unit 33 can also be implemented as one combined circuit module because an existing microprocessor is equipped with both signal processing and high-frequency transmitting functions.

In all of the abovementioned embodiments, the generator 1 of the present invention is set on the wheel rim 2. However, practically, the generator 1 of the present invention can also be firmly set on an additionally-installed wheel cover as an external style, as long as the generator 1 and the tire status sensor 3 are electrically connected to each other. Further, in all of the abovementioned embodiments of the present invention, the tire status sensor 3 is set on the wheel rim 2 in the tire 4. However, practically, the tire status sensor 3 can also be set on the gas nozzle. The abovementioned two variations are also related to the scope of the present invention.

According to the above description, the present invention provides a tire monitoring system without battery. When the vehicle is running, the generator 1 of the present invention can provide energy to the tire status sensor 3. Therefore, the present invention can avoid system failure caused by the battery due to an over-high or over-low environmental temperature, as well as avoid battery replacement. Moreover, the generator 1 of the present invention can provide sufficient energy, such that the tire monitoring system can frequently, almost immediately, report the status of the tire, so as to improve driving safety.

Although the present invention has been explained in relation to its preferred embodiments, it is to be understood that many other possible modifications and variations can be made without departing from the spirit and scope of the invention as hereinafter claimed.

What is claimed is:

1. A tire monitoring system without battery, set on a wheel rim of a tire or in a tire, the tire monitoring system without battery comprising:
a tire status sensor, set in the tire, used for measuring a status in the tire; and
a generator, firmly set on the wheel rim or a wheel cover, and electrically connected to the tire status sensor.

2. The tire monitoring system without battery as claimed in claim 1, wherein the tire status sensor is set on a gas nozzle of the tire.

3. The tire monitoring system without battery as claimed in claim 1, wherein the generator is an alternating current (AC) generator or a direct current (DC) generator.

4. The tire monitoring system without battery as claimed in claim 1 comprising two or more generators.

5. The tire monitoring system without battery as claimed in claim 1, wherein a stator of the generator is composed of an eccentric shaft structure.

6. The tire monitoring system without battery as claimed in claim 1, wherein a stator of the generator is firmly mounted to a weight.

7. The tire monitoring system without battery as claimed in claim 1, wherein a stator of the generator is composed of an eccentric shaft structure and is firmly mounted to a weight.

8. The tire monitoring system without battery as claimed in claim 1, wherein the tire status sensor comprises at least one sensing element, a micro-controlling unit and a data signal transmitter, where the at least one sensing element is capable of sensing the pressure, temperature, humidity or contents of different gases in the tire, and transmitting signals to the micro-controlling unit, the micro-controlling unit is capable of performing processes to the signals from the sensing element, and the data signal transmitter is capable of transmitting the signals to a data signal receiver.

9. The tire monitoring system without battery as claimed in claim 8, wherein the micro-controlling unit and the data signal transmitter of the tire status sensor are implemented as two separate circuit modules.

10. The tire monitoring system without battery as claimed in claim 8, wherein the micro-controlling unit and the data signal transmitter of the tire status sensor are implemented as one combined circuit module.
